(19) United States
(12) Patent Application Publication
(10) Pub. No.: US 2008/0183385 A1
(43) Pub. Date: Jul. 31, 2008

(54) SYSTEM FOR THE DELIVERY OF LOCATION-SPECIFIC AUDIO TOURS

(76) Inventor: Kyle R. Horn, Ames, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 12/022,783

(22) Filed: Jan. 30, 2008

Related U.S. Application Data
(60) Provisional application No. 60/897,944, filed on Jan. 30, 2007.

(51) Int. Cl. G01C 21/00

(52) U.S. Cl. 701/213

(57) ABSTRACT

A system for providing location specific audio tours. The system includes a central processing unit that contains a web portal on the internet that has a plurality of downloadable location specific audio tours. The system includes an electronic device that is able to download the audio tours wherein an accessory is able to be attached to the electronic device that contains a global positioning system (GPS) and switching device to actuate the electronic device to play a specific audio tour when certain GPS coordinates are received.

### CROSS REFERENCE TO RELATED APPLICATION

This application claims the benefit of U.S. Provisional Application No. 60/897,944 filed Jan. 30, 2007.

### BACKGROUND OF THE INVENTION

This invention relates to audio tours. More specifically, this invention relates to an accessory for an electronic device for providing audio tours.

Accessories for MP3 players enjoy enormous popularity. Owners of MP3 players like the iPod™ have demonstrated a keen interest in purchasing products that allow them to exploit their MP3 player to its fullest potential, making MP3 accessories a rapidly-expanding, billion dollar industry.

Several manufacturers currently offer iPod accessories that consist of an FM transmitter and power supply/charging assembly. These accessories enable iPod owners to enjoy their MP3 music over a vehicle sound system, while freed from the constraints of limited battery life.

Currently, owners of MP3 players download millions of songs from the Internet each month through online stores like Apple Computer, Inc.'s iTunes™.

Some companies sell recorded city tours on CD or audiocassette, or allow customers to download audio tours from the Internet for a fee. The user can then record the audio tour onto a CD or store it within an MP3 player. This format offers the benefit of location-specific information, as well as the ability to listen to the tour over the car's audio system. But the format has the disadvantage of requiring actuation by the user—that is, the motorist must trigger the appropriate narrative by pressing “play” in response to external cues.

In the tourism industry, some companies now offer GPS-enabled tours that are delivered through specialized devices that consist of an MP3 player and a GPS actuator integrated into a single unit (examples include CityShow and AudioTrex). Pre-recorded audio tours are stored in the device. The device's GPS actuator automatically triggers tour information at appropriate locations. These specialized units are expensive, and have no utility beyond the tours for which they are designed. Therefore, the units are typically available through short-term rental to tourists.

Owners of MP3 players would substantially benefit from the opportunity to play location-specific tours and information through their personal MP3 players, particularly if this audio content could also be delivered through their vehicle sound systems. Moreover, these consumers would appreciate the ability to conveniently download location-specific tours from the Internet, much like they currently download songs through online music stores such as iTunes. Thus, there is a need in the art for an improved system that provides an inexpensive and simple technique for delivering location-specific audio tours through commonly-owned MP3 players and similar portable electronic devices.

Therefore, a principal object of the present invention is to provide an easily accessed location specific audio tour.

Yet another object of the present invention is to provide an inexpensive manner of receiving a location specific audio tour.

### BRIEF SUMMARY OF THE INVENTION

A system for providing location specific audio tours. The system includes a central processing unit that has internet access wherein a web portal on the internet contains a plurality of downloadable location specific audio tours and corresponding global positioning system tags. An electronic device is detachably and electronically connected to the central processing unit to provide a communication path wherein the location specific audio tours and global positioning system tags are downloaded. An accessory is detachably and electronically connected to the electronic device and has a global positioning system receiver and switching device. Thus, when electronically connected to the accessory, upon receiving global positioning system coordinates the switching device actuates the electronic device to play a location specific audio tour associated with the attached global positioning tag.

### BRIEF DESCRIPTION OF THE DRAWINGS

FIG. 1 is a schematic diagram of a system for providing location specific audio tours.

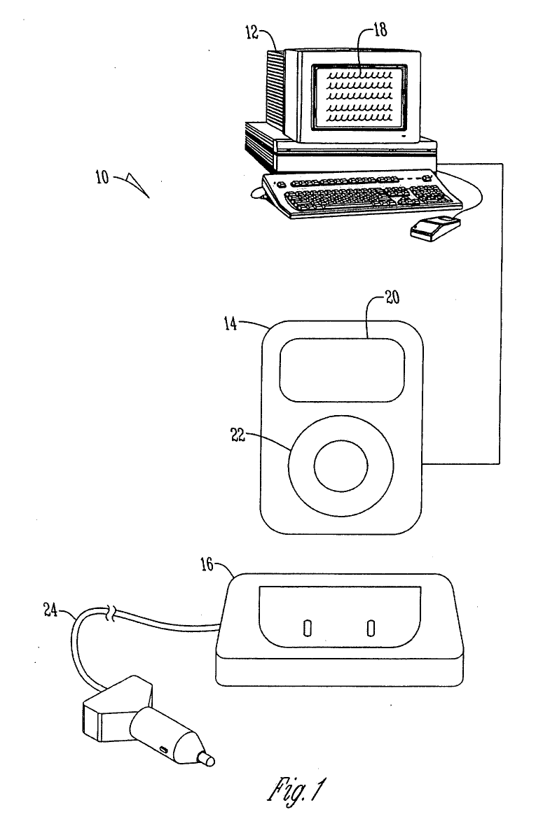

FIG. 2 is a schematic diagram of a system for providing location specific audio tours.

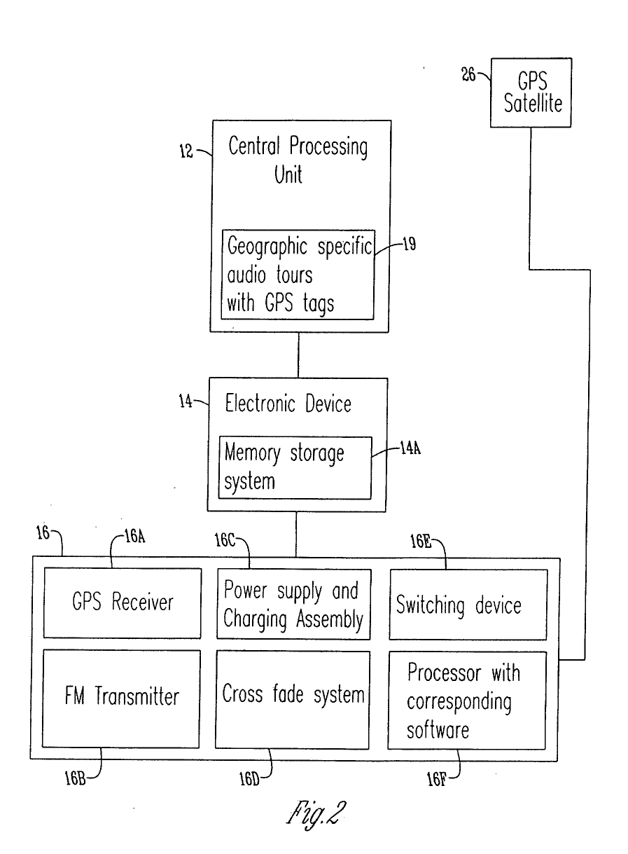

### DETAILED DESCRIPTION OF THE PREFERRED EMBODIMENTS

The figures shows a system 10 for providing location specific audio tours. The system 10 includes a central processing unit 12, an electronic device 14 and an accessory 16 that are used to provide an individual with a location specific audio tour.

The central processing unit 12 can be any type of central processing unit such as a computer, lap top, hand held device, or any other electronic or processing device that has internet access. Thus, by use of the central processing unit 12 a web portal 18 can be accessed by a user. The web portal 18 comprises a web page that contains a plurality of downloadable location specific audio tours 19 wherein each tour has a global positioning system (GPS) tag associated therewith. The audio tours 19 or tour packages include all audio content for a tour in the form of multiple “tracks” (much like a CD) along with GPS coordinates that correspond to each track. These GPS coordinates are referred to as GPS tags. While preferably GPS coordinates are provided in the tags, other information can also be provided. For example only, information with time-specific parameters could be provided as a tag that would enable the system 10 to deliver information consistent with certain times of day. (e.g., an advertisement for lunch specials would be tagged for delivery only during mid-day hours.)

The tracks may also include other location specific media like photos, maps, video or the like. Specifically, the tours are a plurality of downloadable location specific audio tracks 19 and are each downloadable to the electronic device 14. The plurality of downloadable location specific audio tours 19 may include background music which can be employed to introduce the tour and to avoid silence between triggering narrative segments.

The electronic device 14 in a preferred embodiment is an MP3 player. In one embodiment the electronic device 14 has a screen 20 and an actuating device 22 wherein the screen 20 displays information and the actuating device 22 allows operation of the electronic device 14. The electronic device 14 is detachably and electrically connected to the central processing unit 12 through conventional manners such that a communication path between the plurality of downloadable location specific audio tours 19 on the web portal 18 and the electronic device 14 is provided. Other manners of connecting the electronic device and central processing unit, such as wireless connections are also contemplated within the scope of this disclosure.

When actuated the electronic device 14 receives the downloadable location specific audio tours 19 placing them with a memory storage system 14a. Once the plurality of downloadable location specific audio tours 19 are downloaded into the electronic device 14 the electronic device 14 can be detached from the central processing unit 12 and taken to various locations.

The accessory 16 is detachably and electronically connected to the electronic device 14. Alternately, the electronic device 14 may connect with the accessory 16 by wire. The accessory 16 contains a GPS receiver 16a, FM transmitter 16b, a power supply and charging assembly 16c, a cross fade system 16d, a switching device 16e that allows for track selection and a processor with corresponding software 16f. The accessory 16 may optionally have a cord 24 that can be inserted into a power source such as the cigarette lighter plug of a vehicle. In one embodiment the accessory 16 has an FM frequency display window, tuning buttons to adjust FM frequency and a power indicator light.

The GPS receiver 16a allows the accessory 16 to establish GPS coordinates from GPS satellite signals 26. The FM transmitter 16b allows the accessory to be connected to and in communication with a radio within a vehicle such that the audio tours 19 can be played though the sound system of the vehicle. The cross fade system 16d allows music to be included in the audio tour 19 wherein upon completion of an audio track the audio tour 19 fades into music. Similarly, before an audio tour 19 begins music can play and be cross faded into the audio tour 19. The switching device 16e is a device that upon receiving specific GPS coordinates actuates the electronic device 14 to play a location specific audio tour 19 that is associated with an attached GPS tag that is within the electronic device 14.

The processor with corresponding software 16f is optionally able to determine the direction of travel such that more relevant and specific information can be provided regarding the tour. Such information includes instructions to “look to your right” or “look to your left.” The accessory 16 is also detachably connected to the electronic device 14 such that when not in use the accessory 16 may be detached from the electronic device 14 and stored. The software additionally optionally can measure the speed of the accessory 16 wherein depending on the speed the frequency of delivery of information can be altered. Thus if an individual is on a walking tour more audio segments could be accessed as opposed to an individual on a automobile tour.

In operation, when an individual wishes to take a vacation or receive a location specific audio tour 19 the individual goes to the central processing unit 12 to access web portal 18. Once a location specific audio tour 19 is selected the individual connects the electronic device 14 to the central processing unit 12 in order to download the downloadable location specific audio tour 19 from the web portal 18 to the electronic device 14. The individual then detaches the electronic device 14 from the central processing unit 12.

When an individual wishes to listen to a location specific audio tour 19 the individual interconnects the accessory 16 to the electronic device 14. The accessory 16 receives signals from GPS satellites 26 wherein when specific coordinates based on the location of the accessory 16, are recognized as GPS system tagged coordinates. Once recognized the switching device 16e actuates the electronic device 14 to play the location specific audio tour 19 associated with the tag. Upon completion of the audio tour 19 the cross fade system 16d fades the location specific audio tour 19 into background music until another tag is recognized. Thus, no abrupt stops occur and a continuous listening environment is provided for the user.

Tours can be a combination of voices, music and sounds designed to make the travel experience fascinating and memorable. While the content may consist primarily of voice narratives with background music, the narratives can be supplemented with oral histories, theatrical scenes, interviews, period music, and sound effects. These elements will combine to offer travelers an insightful and entertaining view of their surroundings, enhancing the travel experience.

Therefore, provided is a system 10 for providing a location specific audio tour 19. By using an accessory 16 that is inexpensive to manufacture an individual may easily and inexpensively purchase and use the accessory 16 in association with an already purchased electronic device 14. The system 10 is easy to operate and additionally easy to store and can be taken anywhere. Thus, an instant location specific audio tour 19 is provided through the system 10 and at the very least all of the stated objectives have been met.

It will be appreciated by those skilled in the art that other various modifications could be made to the device without departing from the spirit in scope of this invention. All such modifications and changes fall within the scope of the claims and are intended to be covered thereby.

What is claimed is:

1. A system for providing location specific audio tours comprising:
a central processing unit having internet access;
a web portal on the internet containing a plurality of downloadable location specific audio tours and global positioning system tags;
an electronic device connected to the central processing unit to provide a communication path wherein the location specific audio tours and global positioning system tags are downloaded;
an accessory detachably and electronically connected to the electronic device and having a global positioning system receiver and switching device;
wherein upon receiving global positioning system coordinates the switching device actuates the electronic device to play a location specific audio tour associated with an attached global positioning system tag.

2. The system of claim 1 wherein the electronic device an MP3 player.

3. The system of claim 1 wherein the global positioning system coordinates are generated by GPS satellites.

4. The system of claim 1 wherein the accessory has an FM transmitter for connecting to a vehicle's sound system.

5. The system of claim 1 wherein the accessory has a charging assembly.

6. The system of claim 1 wherein the electronic device docks within the accessory.

7. The system of claim 1 wherein the accessory has a cross fade system that fades the location specific audio track into background music upon completion of the location specific audio track.

8. The system of claim 1 wherein the accessory has software that determines the direction of travel of the accessory.

9. The system of claim 1 wherein the accessory has software that measures the speed of the accessory.

10. The system of claim 1 wherein the connection between the electronic device and central processing unit is a detachable and electrical connection.

11. The system of claim 1 wherein the connection between the electronic device and central processing unit is a wireless connection.

12. The system of claim 1 wherein the web portal contains tags having time specific parameters.

13. The system of claim 12 wherein the tags having time specific parameters are advertising.

14. A system for providing location specific audio tours comprising:
an electronic device having a plurality of stored location specific audio tours with global positioning system tags;
an accessory detachably and electronically connected to the electronic device and having a global positioning system receiver and switching device;
wherein upon determining global positioning system coordinates from GPS satellite signals the switching device actuates the electronic device to play a location specific audio tour associated with an attached global positioning system tag.
